(19) United States
(12) Patent Application Publication
(10) Pub. No.: US 2006/0288650 A1
(43) Pub. Date: Dec. 28, 2006

(54) Method for controlling viscosity of slurry and coating slurry for catalyst

(75) Inventors: Michio Tanaka, Kakegawa-shi (JP); Masanori Shimizu, Kakegawa-shi (JP)

Correspondence Address: OLIFF & BERRIDGE, PLC, P.O. BOX 19928, ALEXANDRIA, VA, 22320, US

(73) Assignee: Cataler Corporation, Shizuoka (JP)

(21) Appl. No.: 11/429,179

(22) Filed: May 8, 2006

(30) Foreign Application Priority Data
Jun. 28, 2005 (JP) 2005-188176

(51) Int. Cl. C09K 3/14

(52) U.S. Cl. 51/309

(57) ABSTRACT

A method for controlling a viscosity of a slurry includes the steps of preparing a slurry in which dispersion particles exhibiting a first median diameter are dispersed, and dispersing fine particles exhibiting a second median diameter, which is smaller than the first median diameter of the dispersion particles, in the slurry. When the dispersion particles exhibiting a larger median diameter and the fine particle exhibiting a smaller median diameter make a slurry, the resulting slurry exhibits a reduced viscosity.

### BACKGROUND OF THE INVENTION

1. Field of the Invention

The present invention relates to a coating slurry for a catalyst, coating slurry which is used in the production of exhaust-gas purifying catalysts. More particularly, it relates to a coating slurry for a catalyst, coating slurry whose viscosity is reduced.

2. Description of the Related Art

Exhaust gases, which are emitted from internal combustion engines, such as automotive engines, contain harmful components, such as hydrocarbons (HC), carbon monoxide (CO) and nitrogen oxides (NOₓ). When the exhaust gases are emitted as they are, they cause environmental pollution or environmental deterioration. Accordingly, the exhaust gases have been purified using purifying apparatuses, such as exhaust-gas purifying catalysts, and have been thereafter emitted in the atmosphere.

In general, an exhaust-gas purifying catalyst comprises a catalyst-support substrate, and a catalytic layer. The catalyst-support substrate is formed of a material, such as heat-resistant ceramic and heat-resistant metal. The catalytic layer comprises a heat-resistant porous layer, and a catalytic ingredient. The heat-resistant porous layer is formed on a surface of the catalyst-support substrate. The catalytic ingredient is loaded on the heat-resistant porous layer. The catalytic layer of the exhaust-gas purifying catalyst has been produced in the following manner: a coating slurry for a catalyst is prepared, coating slurry which is composed of a heat-resistant powder containing or being free from the catalytic ingredient; the coating slurry is applied onto the catalyst-support substrate; and thereafter the coating slurry is dried and calcined. Note that the coating slurry has been calcined after carrying out the application and drying of the coating slurry a plurality of times in order to coat the coating slurry on the catalyst-support substrate in a predetermined amount. The coating slurry has been prepared by dispersing a heat-resistant powder, such as activated alumina powder and a ceria powder, in a solvent, such as pure water, along with a binder.

When coating a coating slurry for a catalyst onto a surface of a catalyst-support substrate, the operability depends on the viscosity of the coating slurry. Hence, it has been required to control the viscosity of the coating slurry within a desirable range.

When the viscosity of a coating slurry for a catalyst increases, the flowability of the coating slurry decreases. Accordingly, the coating slurry becomes less likely to be coated onto a surface of a catalyst-support substrate. Specifically, a honeycomb-shaped body, which has a large number of cells, has been used as a catalyst-support substrate for an exhaust-gas purifying catalyst. The coating slurry has been coated onto the cellular inner surfaces of the honeycomb-shaped body to form a catalytic layer. When the viscosity of the coating slurry increases, the coating slurry clogs within the cells. Eventually, the coating slurry has not flowed within the cells.

As a method for reducing the viscosity of a coating slurry for a catalyst, coating slurry whose flowability is decreased, it has been often carried out to employ a method in which a solvent such as water is added to the coating slurry. However, even when the flowability of the coating slurry is improved by adding a solvent, there remains a problem that the coating slurry clogs the catalyst-support substrate's cells. Moreover, adding a solvent to the coating slurry has diminished the amount of powder which can be applied to a surface of a catalyst-support substrate in one coating operation. Accordingly, the number of steps for applying the coating slurry to a surface of a catalyst-support substrate has increased. Moreover, the amount of coating slurry, which is needed to form a predetermined amount of catalytic layer, has increased. Consequently, the coating slurry, which is applied to the inner surface of catalyst-support substrate's cell, has flowed within the cells to clog them.

### SUMMARY OF THE INVENTION

The present invention has been developed in view of the aforementioned circumstance. It is therefore an object of the present invention to provide a coating slurry for a catalyst, coating slurry whose viscosity is controlled adequately.

In order to solve the aforementioned problems, the inventors of the present invention inquired into the characteristics of coating slurries for catalysts over and over again. As a result, they arrived at completing the present invention.

Specifically, a method according to the present invention for controlling a viscosity of a slurry comprises the steps of:

preparing a slurry in which dispersion particles exhibiting a first median diameter are dispersed; and

dispersing fine particles exhibiting a second median diameter, which is smaller than the first median diameter of the dispersion particles, in the slurry.

Moreover, a coating slurry according to the present invention for a catalyst comprises:

a solvent;

dispersion particles dispersed in the solvent, and exhibiting a median diameter of from 3 to 40 μm; and

fine particles dispersed in the solvent, and exhibiting a median diameter of from 0.1 to 2 μm.

The present method can reduce a viscosity of a slurry without changing the slurry's characteristics. Moreover, the present coating slurry exhibits a viscosity which hardly increases excessively during the production of an exhaust-gas purifying catalyst. As a result, the present coating slurry produces an advantage that it is possible to carry out the coating of a catalyst-support substrate with ease during the production of an exhaust-gas purifying catalyst.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a diagram for illustrating measurement results on a viscosity of a coating slurry according to Example No. 1 of the present invention for a catalyst.

FIG. 2 is a diagram for illustrating measurement results on a viscosity of a coating slurry according to Example No. 2 of the present invention for a catalyst.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### Method for Controlling Viscosity

In the present method for controlling a viscosity of a slurry, a slurry in which dispersion particles exhibiting a first median diameter are dispersed is prepared, and fine particles exhibiting a second median diameter, which is smaller than the first median diameter of the dispersion particles, are dispersed in the slurry. The viscosity of the resulting slurry is lowered by dispersing the fine particles having the second median diameter, which is smaller than the first median diameter of the dispersion particles. Note that the “median diameter” herein means such a predetermined diameter that, when particles are divided based on the predetermined particle diameter, a number of particles whose particle diameters are larger than the predetermined particle diameter equals a number particles whose particle diameters are smaller than the predetermined particle diameter.

It has not been clear yet why the viscosity of the resulting slurry is lowered by dispersing the fine particles exhibiting the second median diameter, which is smaller than the first median diameter of the dispersion particles, therein. However, it is assumed as hereinafter described.

First of all, a viscosity of a slurry is increased when dispersion particles absorb a solvent. Specifically, dispersion particles exhibit relatively large particle diameters, and have a large number of pores in the surface. The dispersion particles store the solvent in the pores. The solvent is thus accumulated so that the solvent content decreases in the slurry. As a result, the dispersion particles approach to each other. In a certain case, the dispersion particles form coarse secondary particles with each other. The thus approaching dispersion particles result in increasing the viscosity of the slurry. In view of these, in the present method for controlling a viscosity of a slurry, the fine particles exhibiting the second median diameter, which is smaller than the first median diameter of the dispersion particles, are dispersed in the resulting slurry. When the fine particles are dispersed in the slurry, the fine particles inhibit the dispersion particles from approaching to each other. Therefore, the flowability of the dispersion particles improves so that the viscosity of the slurry decreases.

The second median diameter of the fine particles can preferably be smaller than the first median diameter of the dispersion particles by a factor of from 0.1 to 70%. When the second median diameter of the fine particles is smaller than the first median diameter of the dispersion particles by a factor of from 0.1 to 70%, the fine particles demonstrate the advantage of lowering the viscosity of the resulting slurry. When the second median diameter of the fine particles is smaller than the first median diameter of the dispersion particles by a factor of less than 0.1%, the difference between the particle diameters of the fine particles and the particle diameters of the dispersion particles are so large that the fine particles cannot inhibit the dispersion particles from approaching to each other. Accordingly, no advantage resulting from the addition of the fine particles can be obtained. When the second median diameter of the fine particles is smaller than the first median diameter of the dispersion particles by a factor of more than 70%, the difference between the particle diameters of the fine particles and the particle diameters of the dispersion particles are so small that the fine particles and the dispersion particles approach to each other to result in increasing the viscosity of the resulting slurry. Note that the second median diameter of the fine particles can further preferably be smaller than the first median diameter of the dispersion particles by a factor of from 0.25 to 67%, furthermore preferably from 0.3 to 50%.

The fine particles can preferably comprise spherical fine particles. When the fine particles comprise spherical fine particles, it is possible to move two of the dispersion particles, which approach to each other, along the surface of the fine particles. As a result, it is possible to inhibit the dispersion particles from contacting with each other. Moreover, when the fine particles have irregularities in the surface, the superficial irregularities of the fine particles have engaged with the superficial irregularities of the dispersion particles. Accordingly, the fine particles and the dispersion particles have formed coarse secondary particles. In other words, the fine particles can preferably be free of irregularities in the surface. In addition, when the fine particles are free of irregularities, the solvent does not go into the inside of concavities nor remain therein. Consequently, it is possible to inhibit the concentration of the resulting slurry, and eventually the viscosity thereof, from increasing.

A weight of the fine particles can preferably occupy from 1 to 20% by weight when a summed weight of the dispersion particles and the fine particles is taken as 100% by weight. Specifically, a weight of the fine particles can preferably occupy from 1 to 20% by weight of solid contents, taken as 100% by weight, in the slurry. When the weight proportion of the fine particles is less than 1% by weight, the content of the fine particles are so less that no advantage resulting from the addition of the fine particles can be obtained. On the other hand, when the weight proportion of the fine particles is more than 20% by weight, the viscosity of the resulting slurry has decreased to produce no characteristics as slurry. Note that the weight proportion of the fine particles can further preferably fall in a range of from 1.5 to 15% by weight, furthermore preferably from 2 to 12% by weight, when the summed weight of the dispersion particles and the fine particles taken as 100% by weight.

In the present method for controlling aviscosity of a slurry, the dispersion particles and solvent, which make the slurry, and the fine particles, which are added to the slurry, are not limited in particular. Note that, in the present method, the dispersion particles and fine particles are composed of materials which do not dissolve in the solvent.

### Coating Slurry for Catalyst

The coating slurry according to the present invention for a catalyst comprises a solvent, dispersion particles, and fine particles. The dispersion particles are dispersed in the solvent, and exhibit a median diameter of from 3 to 40 μm. The fine particles are dispersed in the solvent, and exhibit a median diameter of from 0.1 to 2 μm.

A coating slurry for a catalyst here in means a coating slurry which is prepared when an exhaust-gas purifying catalyst is produced, and which is coated onto a catalyst-support substrate. In general, an exhaust-gas purifying catalyst comprises a catalyst-support substrate, a loadinglayer, and a catalytic ingredient. The loading layer is composed of a refractory inorganic oxide, and is formed on the catalyst-support substrate. The catalytic ingredient is loaded on the loading layer. Moreover, the loading layer is produced by applying a slurry, which is composed of a refractory inorganic oxide, onto the catalyst-support substrate, and drying and calcining the slurry. The slurry, which is composed of a refractory inorganic oxide, comprises the present coating slurry. In addition, an exhaust-gas purifying catalyst may further comprise an adsorbent layer, which is composed of an adsorbent such as zeolite. The adsorbent layer is produced by applying a slurry, which is composed of an adsorbent, onto the catalyst-support substrate. That is, the present coating slurry includes such a slurry, which is composed of an adsorbent, as well.

The present coating slurry comprises dispersion particles, which exhibit a larger median diameter and are dispersed in the solvent, and fine particles which exhibit a smaller median diameter and are dispersed in the solvent. Since the present coating slurry comprises the two particles, which exhibit different median diameters to each other and are dispersed in the solvent, it exhibits a reduced viscosity. It is believed that the viscosity reduction occurs because the fine particles inhibit the dispersion particles from approaching to each other to improve the flowability of the dispersion particles, as described above.

The solvent, one of the constituent elements of the present coating slurry, disperses the dispersion particles and fine particles therein. The type of the solvent is not limited in particular. However, the solvent can preferably comprise water, or water-based solvents.

The dispersion particles comprise particles, which are dispersed in the solvent and exhibit a median diameter of from 3 to 40 μm. When the dispersion particles exhibit a median diameter of from 3 to 40 μm, it is possible to form a loading layer on a catalyst-support substrate in the production of exhaust-gas purifying catalysts. Specifically, when the median diameter is less than 3 μm, the particle diameters of the dispersion particles are so small that a loading layer formed of the resulting coating slurry cannot produce pores. Moreover, when the median diameter is less than 3 μm, the difference between the particle diameters of the dispersion particles and the particle diameters of the fine particles is too small to effect the advantage resulting from the addition of the fine particles, as described above. On the other hand, when the median diameter exceeds 40 μm, the sizes of the fine particles with respect to the sizes of the dispersion particles are so small that the fine particle cannot inhibit the dispersion particles from approaching to each other, as described above. In addition, when the median diameter exceeds 40 μm, the weights of the dispersion particles increase so that the dispersion particles are likely to sediment in the resulting coating slurry.

The fine particles comprise particles, which are dispersed in the solvent and exhibit a median diameter of from 0.1 to 2 μm. When the fine particles exhibit a median diameter falling in the range, the resulting coating slurry exhibits a desirably reduced viscosity. When the fine particles exhibit a median diameter of less than 1 μm, the viscosity of the resulting coating slurry decreases excessively so that the resulting coating slurry sediments. On the other hand, when the fine particles exhibit a median diameter of more than 2 μm, the difference between the particle diameters of the dispersion particles and the particle diameters of the fine particles is too small. Therefore, the fine particles act like the dispersion particles so that the viscosity of the resulting coating slurry increases.

In the present coating slurry, material for making the dispersion particles is not limited in particular. It is possible to use substances, which have been used conventionally to form a coating slurry for a catalyst in the production of exhaust-gas purifying catalysts, to make the dispersion particles. As for such substances for making the dispersion particles, it is possible to name particles which are composed of at least one member selected from the group consisting of refractory inorganic oxides, cerium oxide, stabilized zirconium oxides and zeolite, for example. The refractory inorganic oxides can be alumina, for instance.

In the present coating slurry, material for making the fine particles is not limited in particular. It is possible to use substances, which have been used conventionally to form a coating slurry for a catalyst in the production of exhaust-gas purifying catalysts, to make the fine particles. Moreover, it is possible as well to use substances, which hardly change the characteristics of exhaust-gas purifying catalysts to be produced. As for such substances exhibiting such a characteristic, it is possible to name refractory inorganic oxides, barium sulfate and nickel oxide, for example.

The present coating slurry can preferably comprise: the dispersion particles composed of at least one member selected from the group consisting of refractory inorganic oxides, cerium oxide and stabilized zirconium oxides; and the fine particles composed of at least one member selected from the group consisting of barium sulfate and refractory inorganic oxides. The refractory inorganic oxides can be alumina, for instance. The barium sulfate and inorganic oxides hardly degrade the catalytic performance of resulting exhaust-gas purifying catalysts.

The present coating slurry is a slurry which is used when producing exhaust-gas purifying catalysts. Note that the present coating slurry can further comprise an additive, which dissolves in the solvent, in addition to the dispersion particles and fine particles composed of the aforementioned substances. As for the additive, it is possible to name pH adjusters, for example.

The fine particles can preferably exhibit a BET specific surface area of from 0.1 to 10 m²/g. Note that the BET specific surface area herein means a specific surface area found according the Brunauer-Emmett-Teller equation, an expression of the Langmuir isotherm equation in the study of sorption, expression which is used for surface area determinations by computing the mono-layer area. When the fine particles exhibit a BET specific surface area of 10 m²/g or less, they are spherical particles. When the fine particles are spherical particles, it is possible to move two of the dispersion particles, which approach to each other, along the surface of the fine particles. As a result, it is possible to inhibit the dispersion particles from contacting with each other. Moreover, when the fine particles have irregularities in the surface, the superficial irregularities of the fine particles have engaged with the superficial irregularities of the dispersion particles. Accordingly, the fine particles and the dispersion particles have formed coarse secondary particles. In other words, the fine particles can preferably be free of irregularities in the surface. In addition, when the fine particles are free of irregularities, the solvent does not go into the inside of concavities nor remain therein. Consequently, it is possible to inhibit the concentration of the resulting slurry, and eventually the viscosity thereof, from increasing. The fine particles can further preferably exhibit a BET specific surface area of from 0.1 to 9 m²/g, furthermore preferably from 0.1 to 8 m²/g.

A weight of the fine particles can preferably occupy from 1 to 20% by weight of solid contents, taken as 100% by weight, in the present coating slurry. Specifically, a weight of the fine particles can preferably occupy from 1 to 20% by weight when a summed weight of the dispersion particles and the fine particles is taken as 100% by weight. When the weight proportion of the fine particles is less than 1% by weight, the content of the fine particles are so less that no advantage resulting from the addition of the fine particles can be obtained. That is, the viscosity of the resulting slurry does not decrease adequately. On the other hand, when the weight proportion of the fine particles is more than 20% by weight, the resulting slurry is inadequate for producing exhaust-gas purifying catalysts because the viscosity of the resulting slurry has decreased so excessively that the resulting slurry sediments. Note that the weight proportion of the fine particles can further preferably fall in a range of from 1.5 to 15% by weight, furthermore preferably from 2 to 12% by weight, when the summed weight of the dispersion particles and the fine particles taken as 100% by weight.

Moreover, the dispersion particles can preferably exhibit d10 of 1 μm or more, d50 (i.e., the median diameter) of from 3 to 40 μm, and d90 of 50 μm or less. Note that the “d10” herein means such a predetermined diameter that, when particles are divided based on the predetermined particle diameter, particles whose particle diameters are larger than the predetermined particle diameter are present in a proportion of 90% by number; and particles whose particle diameters are smaller than the predetermined particle diameter are present in a proportion of 10% by number. Likewise, the “d90” herein means such a predetermined diameter that, when particles are divided based on the predetermined particle diameter, particles whose particle diameters are larger than the predetermined particle diameter are present in a proportion of 10% by number; and particles whose particle diameters are smaller than the predetermined particle diameter are present in a proportion of 90% by number. The dispersion particles can further preferably exhibit d10 of 1 μm or more, d50 of from 4 to 25 μm, and d90 of 40 μm or less.

A process for producing the present coating slurry is not limited in particular. However, it is possible to produce the present coating slurry in the following manner, for example: a slurry, in which the dispersion particles are dispersed in water, is prepared; and the fine particles are dispersed in the resulting slurry.

The present coating slurry is an example of applying the above-described present method for controlling a viscosity of a slurry to a coating slurry which is used in the production of exhaust-gas purifying catalysts. Accordingly, it is preferable to produce the present coating slurry in the following fashion: a conventionally known slurry is prepared using a conventionally known material; and the fine particles,. which do not affect purifying performance of an exhaust-gas purifying catalyst to be produced, or which improve the purifying performance, are dispersed in the resulting slurry.

The present coating slurry is an example of applying the above-described present method for controlling a viscosity of a slurry to a coating slurry which is used in the production of exhaust-gas purifying catalysts. Since the present coating slurry comprises the fine particles, the present coating slurry can exhibit a reduced viscosity without the addition of solvents. Accordingly, the present coating slurry is free from the drawbacks that result from the fact that slurries exhibit increased viscosities in the production of exhaust-gas purifying catalysts. Consequently, the present coating slurry demonstrates an advantage of reducing the extra man-hour requirement for coping with the drawbacks.

### EXAMPLES

Hereinafter, the present invention will be described with reference to examples.

As an example of the present invention, a coating slurry for a catalyst was produced.

### Example No. 1

First of all, a cerium oxide powder, an aluminum oxide powder, and a zirconium oxide powder were weighed in a proportion of 35:30:35 by weight ratio. Thereafter, the powders were charged into water, and were stirred therein, thereby preparing a raw slurry. When measuring a median diameter of dispersion particles dispersed in the raw slurry, the dispersion particles exhibited a median diameter (or d50) of 15 μm, d10 of 2.5 μm, and d90 of 28 μm. Note that an additive was added to water in an appropriate amount along with the powders when preparing the raw slurry according to Example No. 1. However, the addition of the additive did not change the median diameter of the dispersion particles at all.

The median diameter of the dispersion particles, which were dispersed in the raw slurry was measured in the following manner. A dilute solution of the raw slurry was prepared. The resulting dilute solution was examined with a laser-diffractive grain-size-distribution meter.

Subsequently, a barium sulfate powder was prepared. Note that the barium sulfate powder exhibited a BET specific surface area of 4 m²/g, and a median diameter of 1 μm. The barium sulfate powder was added to the raw slurry. The raw slurry was stirred to disperse the barium sulfate powder therein, thereby preparing a coating slurry for a catalyst according to Example No. 1 of the present invention. Note that the barium sulfate powder was added to the raw slurry in a predetermined amount, which fell in a range of from 0.5 to 28% by weight when the slurry's solid contents after the addition was taken as 100% by weight.

### Evaluation

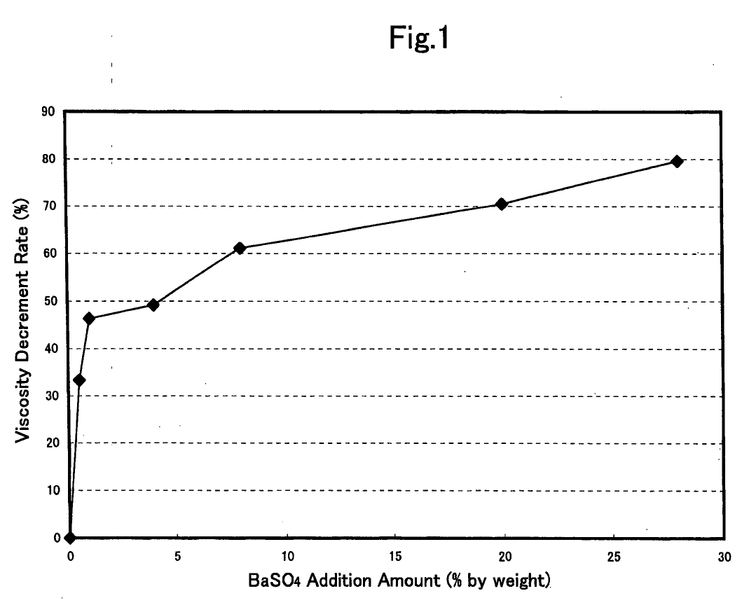

The raw slurry and resultant coating slurry, which were prepared in Example No.1, were subjected to a viscosity measurement. The results of the viscosity measurement are set forth in Table 1, and are illustrated in FIG. 1. Note that FIG. 1 shows a relationship between the addition amount of the barium sulfate powder and the decrement rate of the coating slurry's viscosity. Moreover, the viscosity measurement was carried out using a type “B” viscosimeter whose rotor was rotated at a revolving speed of 60 rpm.

TABLE 1

| Addition Amount of | | Viscosity |
|---|---|---|
| Barium Sulfate | Viscosity | Decrement |
| Powder (% by Weight) | (%) | Rate (%) |
| 0 | 100 | 0 |
| 0.5 | 66.7 | 33.3 |
| 1 | 53.7 | 46.3 |
| 4 | 50.9 | 49.1 |
| 8 | 38.9 | 61.1 |
| 20 | 29.6 | 70.4 |
| 28 | 20.4 | 79.6 |

It is apparent from Table 1 that the viscosity of the coating slurry according to Example No. 1 of the present invention decreased as the addition amount of the barium sulfate powder increased. Moreover, when the barium sulfate powder occupied the coating slurry in a proportion of from 1 to 20% by weight when the content of the coating slurry's solids was taken as 100% by weight, the coating slurry exhibited a viscosity, which fell in a range suggesting that the resulting coating slurry could be handled with ease.

### Example No. 2

First of all, a raw slurry was prepared in the sama manner as Example No. 1. Then, a barium sulfate powder was added to the raw slurry. Note that the barium sulfate powder was added to the raw slurry in an amount of 4% by weight when the slurry's solid contents after the addition was taken as 100% by weight. The raw slurry was stirred to disperse the barium sulfate powder therein, thereby preparing a coating slurry for a catalyst according to Example No.2 of the present invention. Note that the barium sulfate powder, which was added to the raw slurry, exhibited a median diameter falling within a range of from 0.1 to 4 μm. Moreover, the barium sulfate powder, which was added to the raw slurry, exhibited a BET specific surface area as set forth in Table 2.

TABLE 2

| Median Dia. of | | | Viscosity |
|---|---|---|---|
| Barium Sulfate | BET Specific | Viscosity | Decrement |
| Powder (μm) | Surface Area (m²/g) | (%) | Rate (%) |
| 0 | None | 100 | 0 |
| 0.1 | 10 | 39.8 | 60.2 |
| 0.5 | 6.2 | 42.6 | 57.4 |
| 1 | 4 | 50.9 | 49.1 |
| 2 | 0.08 | 53.7 | 46.3 |
| 3 | 0.05 | 77.8 | 22.2 |
| 4 | 0.03 | 106.5 | −6.5 |

### Evaluation

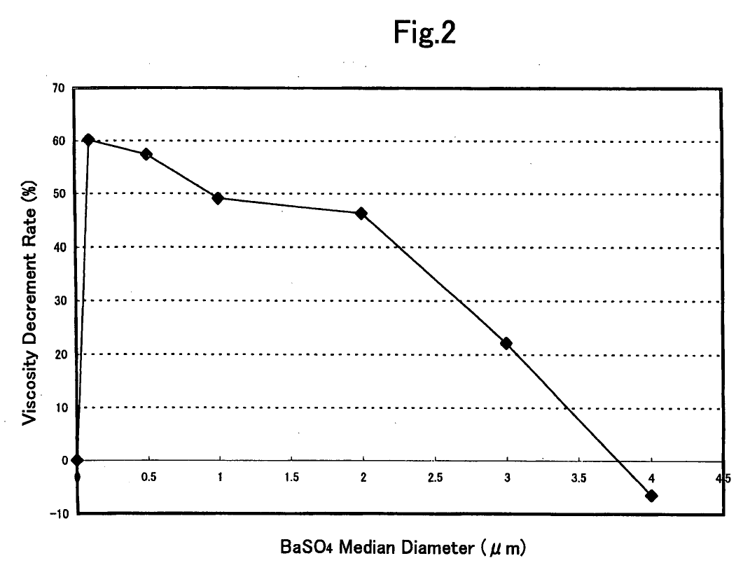

The raw slurry and resultant coating slurry, which were prepared in Example No. 2 were subjected to the same viscosity measurement as described in Example No. 1. The results of the viscosity measurement are set forth in Table 2, and are illustrated in FIG. 2.

As can be appreciated from FIG. 2, the viscosity of the coating slurry decreased when the barium sulfate powder, which exhibited a smaller median diameter, was added to the raw slurry. Moreover, the viscosity of the coating slurry increased as the median diameter of the barium sulfate powder enlarged. Note that, when the median diameter of the barium sulfate powder was greater than 2 μm, the coating slurry exhibited such a high viscosity that it was inappropriate for the production of exhaust-gas purifying catalyst.

Having now fully described the present invention, it will be apparent to one of ordinary skill in the art that many changes and modifications can be made thereto without departing from the spirit or scope of the present invention as set forth herein including the appended claims.

What is claimed is:

1. A method for controlling a viscosity of a slurry, the method comprising the steps of:
preparing a slurry in which dispersion particles exhibiting a first median diameter are dispersed; and
dispersing fine particles exhibiting a second median diameter, which is smaller than the first median diameter of the dispersion particles, in the slurry.

2. The method set forth in claim 1, wherein the second median diameter of the fine particles is smaller than the first median diameter of the dispersion particles by a factor of from 0.1 to 70%.

3. The method set forth in claim 1, wherein the fine particles comprise spherical fine particles.

4. The method set forth in claim 1, wherein a weight of the fine particles occupy from 1 to 20% by weight when a summed weight of the dispersion particles and the fine particles is taken as 100% by weight.

5. A coating slurry for a catalyst, the coating slurry comprising:
a solvent;
dispersion particles dispersed in the solvent, and exhibiting a median diameter of from 3 to 40 μm; and
fine particles dispersed in the solvent, and exhibiting a median diameter of from 0.1 to 2 μm.

6. The coating slurry set forth in claim 5, wherein the fine particles exhibit a BET specific surface area of from 0.1 to 10 m²/g.

7. The coating slurry set forth in claim 5, wherein the fine particles occupy from 1 to 20% by weight when a solid content of the coating slurry is taken as 100% by weight.

8. The coating slurry set forth in claim 5, wherein the dispersion particles comprise at least one member selected from the group consisting of refractory inorganic oxides, cerium oxide and stabilized zirconium oxides.

9. The coating slurry set forth in claim 5, wherein the fine particles comprise at least one member selected from the group consisting of refractory inorganic oxides and barium sulfate.
